(19) United States
(12) Patent Application Publication
(10) Pub. No.: US 2008/0309601 A1
(43) Pub. Date: Dec. 18, 2008

(54) LIQUID CRYSTAL DISPLAY AND LIQUID CRYSTAL DRIVE CIRCUIT

(75) Inventor: Yasutake FURUKOSHI, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 12/137,179

(22) Filed: Jun. 11, 2008

(30) Foreign Application Priority Data
Jun. 12, 2007 (JP) 2007-155274

(51) Int. Cl. G09G 3/36

(52) U.S. Cl. 345/89

(57) ABSTRACT

A liquid crystal display includes pixels, gate lines, source lines and a drive means. Each of the pixels includes a TFT element, a liquid crystal element and an auxiliary capacitive device. One end of the liquid crystal device is connected to one end of the TFT device, and the auxiliary capacitive device is provided to be connected between the one end of the TFT device and an adjacent gate line. In a normal drive mode, the drive means drives each pixel on the basis of an image data acquired through correction which allows image luminance level of the current unit frame to be lowered by a predetermined amount. In an overdrive mode, the drive means drives each pixel on the basis of an image data which brings a larger amount of change of a voltage across the liquid crystal device between the previous unit frame and the current unit frame.

### CROSS REFERENCES TO RELATED APPLICATIONS

The present invention contains subject matter related to Japanese Patent Application JP 2007-155274 filed in the Japanese Patent Office on Jun. 12, 2007, the entire contents of which being incorporated herein by reference.

### BACKGROUND OF THE INVENTION

1. Field of the Invention

The present invention relates to a liquid crystal display including an auxiliary capacitive element, and a liquid crystal drive circuit applied to such a liquid crystal display.

2. Description of the Related Art

In recent years, there have been widely utilized liquid crystal displays which display video images by driving display elements (liquid crystal elements) using liquid crystal. In such a liquid crystal display, light from a light source is transmitted and modulated by changing an alignment of liquid crystal molecules in a liquid crystal layer sealed between substrates such as glass substrates, and thereby displays are performed.

Also, in such a liquid crystal display of the related art, in the case that an amount of change of a voltage applied to the liquid crystal element is large, a predetermined overdrive voltage is added to the voltage which is based on an image data (driven by the overdrive), and thereby the response speed of the liquid crystal is improved (for example, Japanese Unexamined Patent Publication No. 2007-11285).

As a technique different from the one described above, there has been proposed a liquid crystal display where an auxiliary capacitive element is formed in each pixel of the liquid crystal display in order to stabilize the voltage applied to the liquid crystal element, and the voltage across the auxiliary capacitive element is changed so that the voltage across the liquid crystal element is also changed (Cs on gate method) (for example, Japanese Unexamined Patent Publication No. Hei-4-145490).

### SUMMARY OF THE INVENTION

Here, in the liquid crystal display of the related art, the voltage higher than a resisting pressure of a drive element (TFT (thin film transistor) element) may not be applied to the liquid crystal element. Thus, for example, at the time of a transition from a black display state to a white display state, or the transition from the white display state to the black display state, the overdrive voltage as described above may not be added. As a result, the overdrive is applicable only to the transition in the vicinity of an intermediate gradation. That is, because the overdrive voltage may not be added for the transition in which the amount of the change of the voltage is largest, the overdrive is inapplicable when the response speed of the liquid crystal is most necessarily improved. This means that the improvement of the response speed of the liquid crystal is insufficient.

Also, if the resisting pressures of a power supply voltage and the drive element are set higher than the original values thereof, the higher voltage is applicable to the liquid crystal element correspondingly, and the response speed of the liquid crystal is also improved. However, as a result, the electric power consumption is increased or the heat release value is increased so that issues including a decrease of reliability in the drive elements or the like occur.

In this way, in the related art, it is difficult to improve the response speed of the liquid crystal without increasing the resisting pressure of the drive element, but there is still room for improvement.

In view of the foregoing, it is desirable to provide a liquid crystal display and a liquid crystal drive circuit capable of improving the response speed of a liquid crystal without increasing the resisting pressure of the drive element.

According to an embodiment of the present invention, there is provided a liquid crystal display including a plurality of pixels disposed in a matrix form while each of the pixel includes a TFT element, a liquid crystal element functioning as a main capacitive element, and an auxiliary capacitive element, a gate line selecting a pixel to be driven in a line-sequential manner so that the TFT element in the selected pixel is selectively changed to on-state through application of on-voltage, and selectively changed to off-state through application of off-voltages, a source line supplying an image data to the pixel to be driven through the TFT element, and a drive means for driving the pixels for display in a line-sequential manner. One end of the liquid crystal element is connected to one end of the TFT element, and one end of the auxiliary capacitive element is connected to the one end of the TFT element, while other end of the auxiliary capacitive element is connected to an adjacent gate line, and the drive means refers to image data both of a current unit frame and a previous unit frame. Thus, in a normal drive mode, the drive means drives the pixels one by one on the basis of an image data obtained through correction in which image luminance level of the current unit frame is lowered by a predetermined amount, and in an overdrive mode, the drive means drives the pixels one by one on the basis of an image data which allows a larger change of a voltage across the liquid crystal element between the previous unit frame and the current unit frame.

According to an embodiment of the present invention, there is provided a liquid crystal drive circuit being applied to a liquid crystal display including a plurality of pixels disposed in a matrix form while each of the pixel including a TFT element, a liquid crystal element functioning as a main capacitive element, and an auxiliary capacitive element, a gate line selecting a pixel to be driven in a line-sequential manner so that the TFT element in the selected pixel is selectively changed to on-state through application of on-voltage, and selectively changed to off-state through application of off-voltages, and a source line supplying an image data to the pixel to be driven through the TFT element, the liquid crystal drive circuit driving the pixels for display in a line-sequential manner. One end of the liquid crystal element is connected to one end of the TFT element, one end of the auxiliary capacitive element is connected to the one end of the TFT element while other end of the auxiliary capacitive element is connected to an adjacent gate line, and the drive means refers to image data both of a current unit frame and a previous unit frame. Thus, in a normal drive mode, the drive means drives the pixels one by one on the basis of an image data obtained through correction in which image luminance level of the current unit frame is lowered by a predetermined amount, and in an overdrive mode, the drive means drives the pixels one by one on the basis of an image data which allows a larger change of a voltage across the liquid crystal element between the previous unit frame and the current unit frame.

In the liquid crystal display and the liquid crystal drive circuit of the embodiment of the present invention, when the TFT element in the pixel to be driven selectively becomes on-state by an on-voltage supplied from the gate line, an image data is supplied from the source line through the TFT element, and the voltage on the basis of the image data is respectively applied across the liquid crystal element and the auxiliary capacitive element in the pixel. Then, when the TFT element selectively becomes off-state by one of the plurality of kinds of off-voltages supplied from the gate line, a supply of the image data from the source line is stopped, and the voltage across the liquid crystal element and the auxiliary capacitive element is maintained. After that, when an electric potential of the plurality of kinds of off-state voltages is changed with time and supplied to the other end of the auxiliary capacitive element by the adjacent gate line, the voltage across the auxiliary capacitive element and the liquid crystal element is changed from the voltage on the basis of the abovementioned image data. Here, in the normal drive mode, because the display is driven on the basis of the image data after being corrected in a manner that the luminance level of the image data of the current unit frame is decreased by a predetermined amount, on the basis of the image data after being corrected as described above, it is adjustable that the original voltage value on the basis of the image data before being corrected is respectively applied across the auxiliary capacitive element and the liquid crystal element (that is, the overdrive is not performed, that is, the normal drive is performed), after the voltage across the auxiliary capacitive element and the liquid crystal element is changed. In the overdrive mode, because the display is driven on the basis of the image data in which the voltage change across the liquid crystal element becomes larger than the original voltage change on the basis of the image data of the current unit frame, the voltage value larger than the original voltage value on the basis of the image data is respectively applied across the auxiliary capacitive element and the liquid crystal element, after the voltage across the auxiliary capacitive element and liquid crystal element is changed as described above. Thereby, the display in which the voltage change becomes larger than the original voltage change is performed, that is, the overdrive is performed.

In the liquid crystal display of the embodiment of the present invention, in the overdrive mode, the drive means may perform the overdrive mode by using the image data of the current unit frame without changing the luminance level of the image data of the current frame, for the pixel changed from a black display state to a white display state. In such a configuration, the voltage value larger than the original voltage value of the white display state on the basis of the image data is respectively applied across the auxiliary capacitive element and the liquid crystal element, after the voltage across the auxiliary capacitive element and the liquid crystal element is changed. Thus, the display drive in which the voltage change becomes larger than the original voltage change at the time of the transition from the black display state to the white display state may be performed. That is, the overdrive may be performed at the time of the transition from the black display state to the white display state.

In the overdrive mode, for the pixel where the transition is made from the white display state to the black display state, the drive means may perform the overdrive mode by using the image data after being corrected in such a manner that the luminance level of the image data of the current unit frame is highly lowered by an amount which is larger than the predetermined amount in the normal drive. In such a configuration, the voltage value smaller than the original voltage value of the black display state on the basis of the image data is respectively applied across the auxiliary capacitive element and the liquid crystal element, after the voltage across the auxiliary capacitive element and the liquid crystal element is changed. Thus, the display drive in which the voltage change becomes larger than the original voltage change at the time of the transition from the white display state to the black display state may be performed. That is, the overdrive may be performed at the time of the transition from the white display state to the black display state.

In the liquid crystal display of the embodiment of the present invention, the image luminance level based on corrected image data after stabilization of the voltage across the liquid crystal element in the normal drive mode is equivalent to a image luminance level based on non-corrected image data just after application of a voltage across the liquid crystal element. In such a configuration, when the voltage across the auxiliary capacitive element and the liquid crystal element is changed so that the voltage across the liquid crystal element is in the stable state, the luminance level on the basis of the image data after being corrected becomes equivalent to the luminance level on the basis of the image data before being corrected. Thus, the overdrive as described above may be performed while adjusting so that the luminance level in the normal drive is unchanged (that is, while adjusting so that the change of the display luminance is not accompanied).

According to the liquid crystal display or the liquid crystal drive circuit of the embodiment of the present invention, in the normal drive mode, because the display is driven on the basis of the image data after being corrected in a manner that the luminance level of the image data of the current unit frame is decreased by a predetermined amount, on the basis of the image data after being corrected, it is adjustable that the original voltage value on the basis of the image data before being corrected is respectively applied across the auxiliary capacitive element and the liquid crystal element, after the voltage across the auxiliary capacitive element and the liquid crystal element is changed. Also, in the overdrive mode, because the display is driven on the basis of the image data in which the voltage across the liquid crystal element becomes larger than the original voltage value on the basis of the image data of the current unit frame, the voltage value larger than the original voltage value on the basis of the image data is respectively applied across the auxiliary capacitive element and the liquid crystal element, after the voltage across the auxiliary capacitive element and the liquid crystal element is changed, and thereby the overdrive may be performed. Therefore, the response speed of the liquid crystal may be improved without increasing the resisting pressure of the drive element. Other and further objects, features and advantages of the invention will appear more fully from the following description.

### BRIEF DESCRIPTION OF THE DRAWINGS

FIG. 1 is a block diagram illustrating an overall configuration of an image display according to an embodiment of the present invention.

FIG. 2 is a circuit diagram illustrating a detailed configuration of a pixel circuit unit formed in each pixel shown in FIG. 1.

FIG. 3 is a view illustrating an example of a look-up table used in an overdrive process section shown in FIG. 1.

FIG. 4 is a circuit diagram illustrating a configuration of a shift register section included in a gate driver shown in FIG. 1.

FIG. 5 is a circuit diagram illustrating a configuration of an output section included in the gate driver shown in FIG. 1.

FIGS. 6A to 61 are timing waveform diagrams for illustrating an operation of the gate driver.

FIG. 7 is a flow chart for illustrating the operation of the overdrive process section.

FIGS. 8A to 8E are timing diagrams for illustrating the operation of the overdrive process section.

FIG. 9 is a timing waveform diagram for illustrating the operation of the overdrive process section.

FIG. 10 is another timing waveform diagram for illustrating the operation of the overdrive process section.

FIGS. 11A and 11B are timing waveform diagrams illustrating voltages applied to a liquid crystal element when the overdrive is performed.

FIG. 12 is a block diagram illustrating an overall configuration of an image display apparatus according to a modification of the present invention.

FIG. 13 is circuit diagram illustrating a detailed configuration of a pixel circuit unit formed in each pixel shown in FIG. 12.

### DETAILED DESCRIPTION OF THE PREFERRED EMBODIMENTS

Preferred embodiments of the present invention will be described in detail with reference to the accompanying drawings.

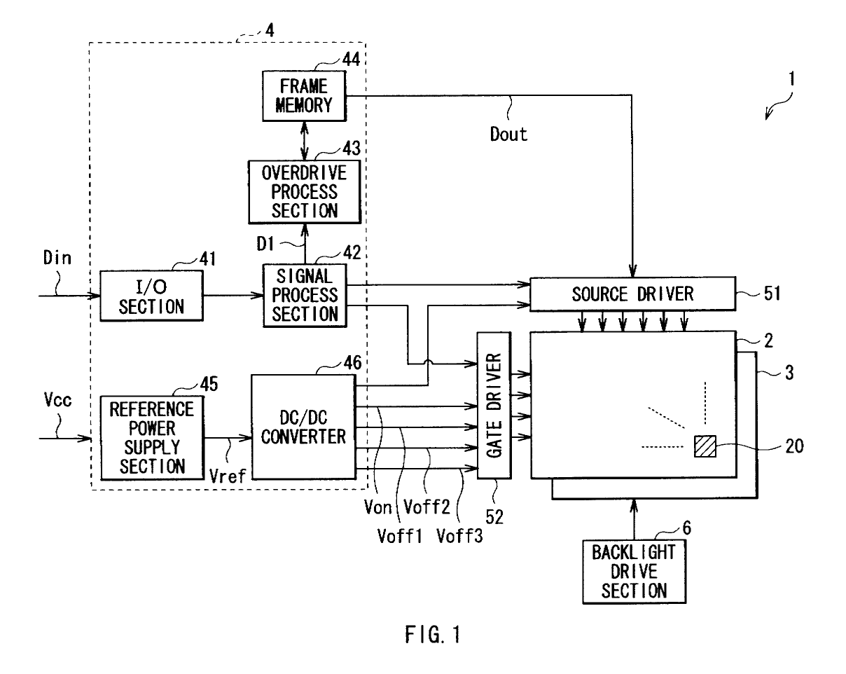

FIG. 1 shows an overall configuration of a liquid crystal display (liquid crystal display 1) according to an embodiment of the present invention. The liquid crystal display 1 includes a liquid crystal display panel 2, a backlight section 3, a timing controller 4, a source driver 51 and a gate driver 52, and a backlight drive section 6.

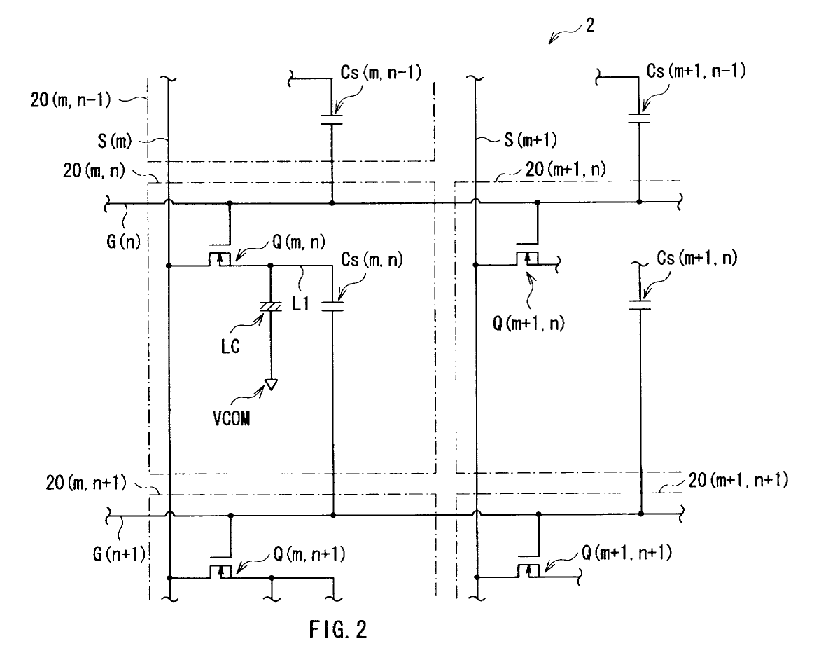

The liquid crystal display panel 2 performs an image display on the basis of an input image signal Din by a drive signal supplied from the source driver 51 and the gate driver 52 which will be described later. The liquid crystal display panel 2 includes a plurality of pixels 20 disposed side by side in a matrix shape. In each of the pixels 20, a pixel circuit unit (refer to FIG. 2) which will be described later is formed. The detailed configuration of the pixel circuit unit will be described later.

The backlight section 3 is a light source emitting light with respect to the liquid crystal display panel 2, and includes, for example, a CCFL (cold cathode fluorescent lamp), an LED (light emitting diode), or the like.

The timing controller 4 has an I/O section 41, a signal process section 42, an overdrive process section 43, a frame memory 44, a reference power supply section 45, and a DC/DC converter 46. The timing controller 4 performs a predetermined signal process which will be described later to the input image signal Din (luminance signal) from the external in order to generate a image signal Dout which is an RGB signal and generate a voltage used in the source driver 51 and the gate driver 52 on the basis of the supply of the power supply voltage Vcc. The timing controller 4 also has a function to control a drive timing of the source driver 51 and the gate driver 52.

The I/O section 41 inputs the input image signal Din in order to supply it to the signal process section 42. The signal process section 42 performs a predetermined signal process to the input image signal Din supplied from the I/O section 41. The signal process section 42 supplies a image signal D1 which is the RGB signal to an overdrive process section 43, and generates a drive timing control signal of the source driver 51 and the gate driver 52 and supplies the driving timing control signal to the source driver 51 and the gate driver 52.

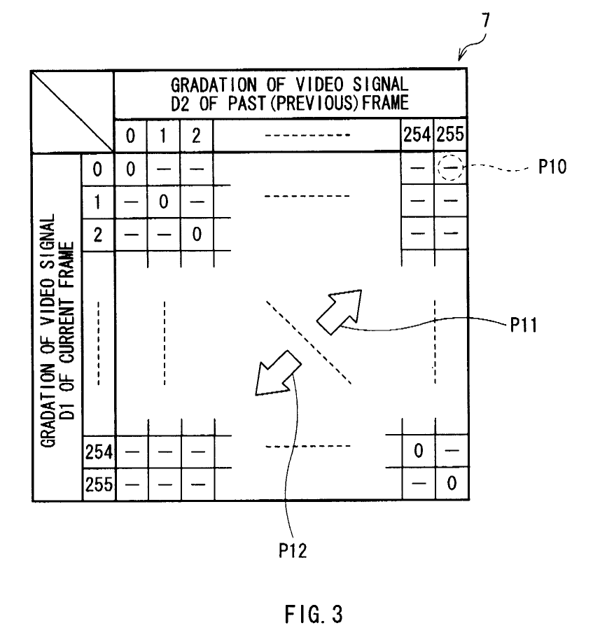

For each of the pixels 20 in the current frame, the overdrive process section 43 determines to perform either the display of the normal drive or the display of the overdrive, on the basis of the image signal D1 of the current frame supplied from the signal process section 42 and the image signal D2 (not shown in the figure) of the previous (last) frame stored in the frame memory 44 which will be described later. Also, according to the determination result, the overdrive process section 43 performs a correction to the image signal D1 of the current frame for each of the pixels 20, and writes (performs storing), on the frame memory 44, the image signal D2 after being corrected (the detailed process will be described later). In addition, for the abovementioned determination process of the drive method and the correction process of the image signal D1 of the current frame, for example as shown in FIG. 3, used is a look-up table 7 showing the relationship between a gradation (for example, 0 to 255 gradation) of the image signal D1 of the current frame and the gradation (for example, 0 to 255 gradation) of the image signal D2 of the past (previous) frame, and the gradation of the image signal of the current frame after being corrected. The determination process of the drive method and the correction process of the image signal D1 of the current frame will be described later in detail.

The frame memory 44 stores the image signal corrected by the overdrive process section 43 (the image signal after being processed) as the image signal D2 per frame unit.

On the basis of the power supply voltage Vcc, the reference power supply section 45 generates a reference voltage Vref which is a reference voltage of the DC/DC converter 46. The DC/DC converter 46 performs a predetermined conversion of a direct voltage on the basis of the supplied reference voltage Vref. Thus, the DC/DC converter 46 generates voltages respectively used in the power supply voltage of the source driver 51 and the voltage of the gate driver 52 (a gate-on voltage Von and a plurality of kinds of gate-off voltages Voff1, Voff2, and Voff3 which will be described later), and supplies the generated voltages to the source driver 51 and the gate driver 52.

The source driver 51 inputs, as a image signal Dout, the image signal D2 of the current frame which is stored in the frame memory 44, according to the drive timing control signal supplied from the signal process section 42, and supplies the drive voltage (a source voltage which will be described later) on the basis of the image signal Dout, to each of the pixels 20 of the liquid crystal display panel 2.

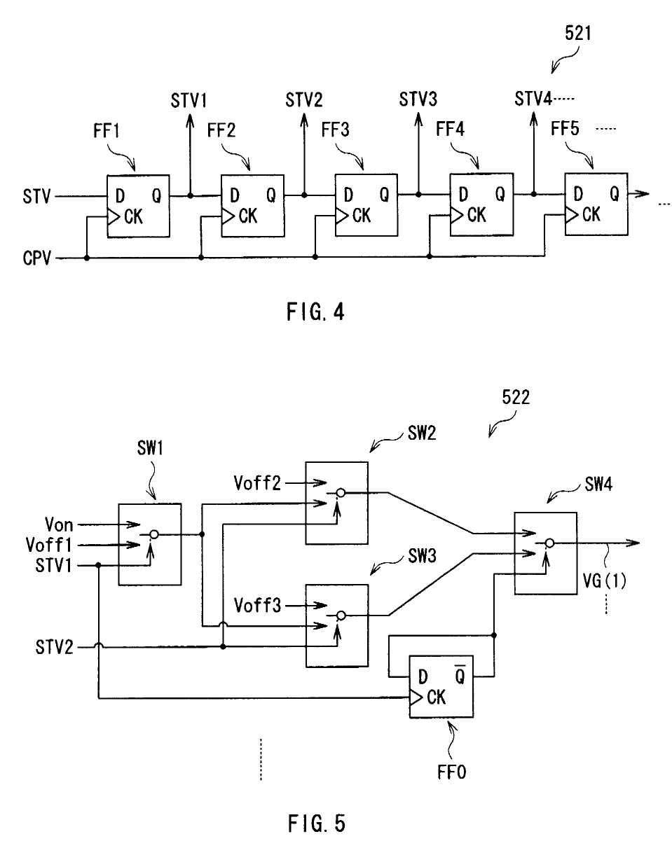

According to the drive timing control signal supplied from the signal process section 42, the gate driver 52 line-sequentially drives each of the pixels 20 in the liquid crystal display panel 2 along a gate line which will be described later, on the basis of the supply voltages (the gate-on voltage Von and the gate-off voltages Voff1, Voff2, Voff3) from the DC/DC converter 46. The detailed configuration of the gate driver 52 will be described later (FIGS. 4 and 5).

The backlight drive section 6 controls a lighting operation of the backlight section 3, and includes, for example, an inverter circuit.

Next, with reference to FIG. 2, the configuration of the pixel circuit unit (liquid crystal display element) formed in each of the pixels 20 will be described in detail. FIG. 2 shows an example of a circuit configuration of the pixel circuit unit in the pixel 20. References m and n in FIG. 2 respectively indicate natural numbers, and the pixel 20 (m, n) indicates the pixel which is located in the coordinates (m, n) among the plurality of pixels 20.

In the pixel 20 (m, n), formed is the pixel circuit unit composed of a liquid crystal element LC which functions as a main capacitive element, an auxiliary capacitive element Cs, and a TFT element Q (m, n). To the pixel 20 (m, n), connected is a gate line G (n) which line-sequentially selects the pixel circuit unit to be driven so that the TFT element Q in the pixel circuit unit selectively becomes on-state by the gate-on voltage Von, and the TFT element Q selectively becomes off-state by the plurality of kinds of gate-off voltages Voff1, Voff2, and Voff3. Also, to the pixel 20 (m, n), connected is a source line S (m) which supplies the image data (image signal Dout) to the pixel circuit unit to be driven through the TFT element Q in that pixel circuit unit. The gate line G (n) also functions as the auxiliary capacitive line of the pixel 20 (m, n−1) or the like extending along the gate line G (n−1), as will be described later.

The pixel 20 (m, n+1) which is located adjacent to the pixel 20 (m, n) in a direction of the line-sequential operation along the source line S (m) includes the TFT element Q (m, n+1) as shown in FIG. 2, and the gate line G (n+1) and the source line S (m) are connected to the pixel 20 (m, n+1). The pixel 20 (m, n−1) which is located adjacent to the pixel 20 (m, n) in the direction opposite to the direction of the line-sequential operation along the source line S (m) includes the auxiliary capacitive element Cs (m, n−1) as shown in FIG. 2, and the gate line G (n−1) which is not shown in the figure and the source line S (m) are connected to the pixel 20 (m, n−1). Also, the pixel 20 (m+1, n) which is located adjacent to the pixel 20 (m, n) along the gate line G (n) includes the TFT element Q (m+1, n) and the auxiliary capacitive element Cs (m+1, n) as shown in FIG. 2, and the gate line G (n) and the source line S (m+l) are connected to the pixel 20 (m+1, n). Further, the pixel 20 (m+1, n+1) which is located adjacent to the pixel 20 (m+1, n) in the direction of the line-sequential operation along the source line S (m+1) includes the TFT element Q (m+1, n+1) as shown in FIG. 2, and the gate line G (n+1) and the source line S (m+1) are connected to the pixel 20 (m+1, n+1). The pixel 20 (m+1, n−1) (not shown in the figure) which is located adjacent to the pixel 20 (m+1, n) in the direction opposite to the direction of the line-sequential operation along the source line S (m+1) includes the auxiliary capacitive element Cs (m+1, n−1), and the gate line G (n−1) which is not shown in the figure and the source line S (m+1) are connected to the pixel 20 (m+1, n−1).

The liquid crystal element LC functions as a display element operating a display (emitting a display light) according to the image signal Dout supplied to one end of the liquid crystal element LC from the source line S (m) through the TFT element Q (m, n), and includes a liquid crystal layer which is not shown in the figure and a pair of electrodes with the liquid crystal layer in between. One (one end) of the pair of electrodes is connected to one end of the source of the TFT element Q (m, n) and one end of the auxiliary capacitive element Cs through a connection line L1, and the other (other end) of the pair of electrodes is connected to a common electrode VCOM. The abovementioned liquid crystal layer is, for example, composed of the liquid crystal of TN (twisted nematic) mode.

The auxiliary capacitive element Cs is a capacitive element for stabilizing accumulated electric charge of the liquid crystal element LC, and one end (one of the electrodes) of the auxiliary capacitive element Cs is connected to the one end of the liquid crystal element LC and the source of the TFT element Q (m, n) through the connection line L1, and the other end (facing electrode) of the auxiliary capacitive element Cs is connected to the adjacent gate line G (n+1) which is the gate line located adjacent in the direction of the line-sequential operation along the source line S (m). By such a configuration, the pixel circuit unit in each of the pixels 20 functions as the pixel circuit unit of a so-called Cs on gate method which will be described later in detail.

The TFT element Q (m, n) is configured by MOS-FET (metal oxide semiconductor-field effect transistor). The gate of the TFT element Q (m, n) is connected to the gate line G (n), the source of the TFT element Q (m, n) is connected to the one end of the liquid crystal element LC and the one end of the auxiliary capacitive element Cs through the connection line L1, and the drain of the TFT element Q (m, n) is connected to the source line S (m). This TFT element Q (m, n) functions as a switching element for supplying the image signal Dout to the one end of the liquid crystal element LC and the one end of the auxiliary capacitive element Cs. Specifically, according to the selection signal (gate signal) supplied from the gate driver 52 through the gate line G (n), the TFT element Q (m, n) selectively conducts (switches to on-state) between the source line S (m), and the one end of the liquid crystal element LC and the one end of the auxiliary capacitive element Cs in the pixel 20 (m, n).

Next, with reference to FIGS. 4 and 5, the circuit configuration of the gate driver 52 will be described in detail. The gate driver 52 includes a shift register section 521 as shown in FIG. 4 and an output section 522 as shown in FIG. 5.

On the basis of a strobe signal STV and a pulse signal (clock signal) CPV as drive timing control signals supplied from the signal process section 42, the shift register section 521 generates the strobe signals STV1, STV2, STV3, STV4, . . . which sequentially become an “H” state at different timings in the way which will be described later. The shift register section 521 includes a plurality of flip-flop circuits (for example, the flip-flop circuits FF1 to FF5, . . . as shown in FIG. 4). The strobe signal STV is supplied to a data input terminal D of the flip-flop circuit FF1, and the pulse signal CPV is supplied in parallel with each other to a clock terminal CK of each of the flip-flop circuits FF1, FF2, FF3, FF4, FF5, . . . Also, the strobe signal STV1 is outputted from a data output terminal Q of the flip-flop circuit FF1, and the strobe signal STV1 is supplied to the data input terminal D of the flip-flop terminal 2. The strobe signal STV 2 is outputted from the data output terminal Q of the flip-flop circuit FF2, and the strobe signal STV2 is supplied to the data input terminal D of the flip-flop circuit FF3. The strobe signal STV3 is outputted from the data output terminal Q of the flip-flop circuit FF3, and the strobe signal STV 3 is supplied to the data input terminal D of the flip-flop circuit FF4. The strobe signal STV4 is outputted from the data output terminal Q of the flip-flop terminal FF4, and the strobe signal STV4 is supplied to the data input terminal D of the flip-flop circuit FF5.

The output section 522 generates gate signals (gate voltages VG(1), VG(2), . . . ) which are output signals of the gate driver 52, on the basis of the strobe signals STV1, STV2, STV3, STV4 . . . supplied from the shift register section 521, and the gate-on voltage Von and the gate-off voltages Voff1, Voff2, and Voff3 supplied from the DC/DC converter 46. For each of the gate voltages, the output section 522 includes four analogue switch sections (for example, analogue switch sections SW1 to SW4 for the gate voltage VG(1), as shown in FIG. 5), and one flip-flop circuit (for example, a flip-flop circuit FF0 for the gate voltage VG(1), as shown in FIG. 5). Here, the analogue switches SW1 to SW4 and the flip-flop circuit FF0 for the gate voltage VG(1) will be representatively described. The analogue switch SW1 selectively outputs one of the gate-on voltage Von and the gate-off voltage Voff1 according to the value of the strobe signal STV1 (specifically, the gate voltage Von is selectively outputted when the strobe signal STV1=“H”, and on the other hand, the gate-off voltage Voff1 is selectively outputted when the strobe signal STV1=“L”). The analogue signal SW2 selectively outputs one of the gate-off voltage Voff2 and the output voltage from the analogue switch SW1 according to the value of the strobe signal STV2 (specifically, the gate-off voltage Voff2 is selectively outputted when the strobe signal STV2=“H”, and on the other hand, the output voltage from the analogue switch SW1 is selectively outputted when the strobe signal STV 2=“L”). The analogue signal SW3 selectively outputs one of the gate-off voltage Voff3 and the output voltage from the analogue switch SW1 according to the value of the strobe signal STV2 (specifically, the gate-off voltage Voff3 is selectively outputted when the strobe signal STV 2=“H”, and on the other hand, the output voltage from the analogue switch SW1 is selectively outputted when the strobe signal STV2=“L”). The flip-flop circuit FF0 inputs the strobe signal STV1 to the clock terminal CK, and supplies the output data from an inversion data output terminal Q to the data input terminal D and a selection terminal of the analogue switch SW4. Thus, the flip-flop circuit FF0 functions as a toggle signal generation section alternately generating signals of “H” state and “L” state. The analogue switch SW4 selects one of the output voltage from the analogue switch SW2 and the output voltage from the analogue switch SW3 according to the value of the abovementioned toggle signal supplied from the flip-flop circuit FF0 (specifically, the output voltage from the analogue switch SW2 is selected when the toggle signal=“H”, and on the other hand, the output voltage from the analogue switch SW3 is selected when the toggle signal=“L”) so as to output the output voltage as the gate voltage VG(1).

Here, the timing controller 4, and the source driver 51 and the gate driver 52 correspond to the examples of a drive means and a liquid crystal drive circuit in the present invention. The overdrive process section 43 corresponds to the examples of a determination means and a correction means in the present invention.

Next, the operation of the liquid crystal display 1 of the embodiment having such a configuration will be described in detail.

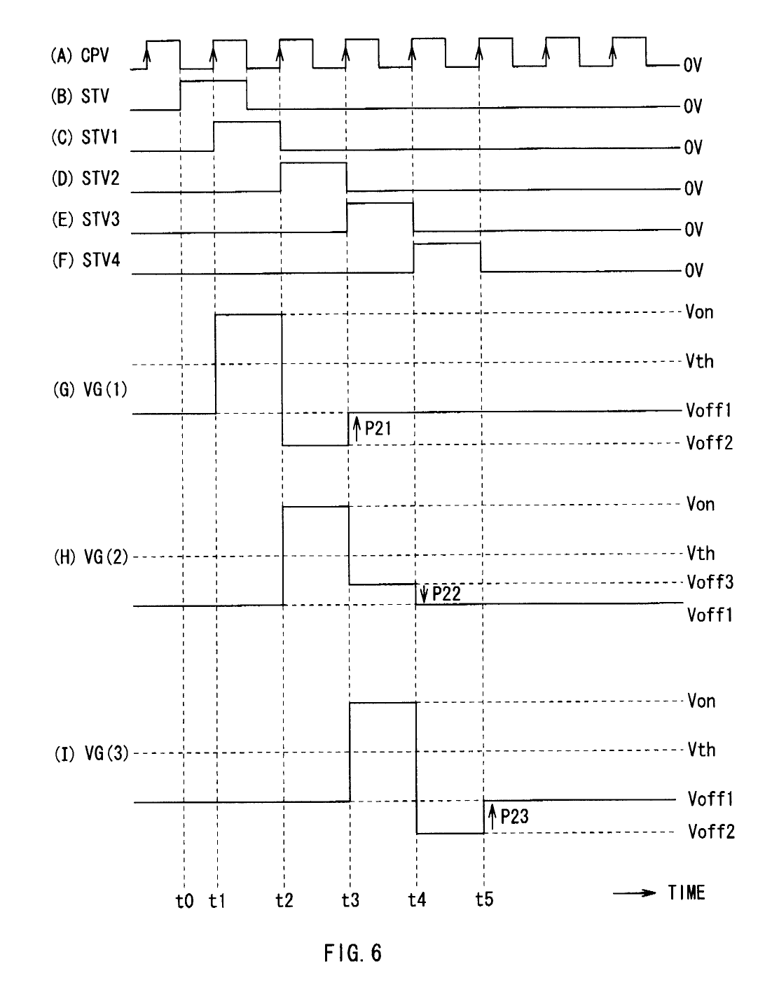

With reference to FIGS. 1 to 2, and FIGS. 4 to 6, the overall operation of the liquid crystal display 1 will be described. Here, FIG. 6 shows a timing waveform diagram of the operation of the gate driver 52, while (A) showing a voltage waveform of the pulse signal (clock signal) CPV, (B) to (F) respectively showing the voltage waveforms of the strobe signal STV and the strobe signals STV1 to STV4, and (G) to (I) respectively showing the voltage waveforms of the gate voltages VG(1) to VG(3) respectively indicating the voltages of the gate signals G(1) to G(3).

As shown in FIG. 1, in the timing controller 4 of the liquid crystal display 1, the input image signal Din from the external is subjected to the predetermined signal process so that the image signal Dout which is the RGB signal is generated, and the voltages to be used in the source driver 51 and the gate driver 52 are generated on the basis of the supply of the power supply voltage Vcc.

Specifically, the input image signal Din inputted through the I/O section 41 is subjected to the predetermined signal process by the signal process section 42 so that the image signal D1 which is the RGB signal is generated. Also, the drive timing control signals of the source driver 51 and the gate driver 52 are generated in the signal process section 42, and are supplied to the source driver 51 and the gate driver 52.

Next, in the overdrive process section 43, on the basis of the image signal D1 of the current frame supplied from the signal process section 42, and the image signal D2 of the previous (last) frame stored in the frame memory 44, the determination process of the drive method and the correction process of the image signal D1 of the current frame which will be described later are performed for each of the pixels 20, and thus the image signal D2 after being corrected is written on the frame memory 44.

On the other hand, on the basis of the reference voltage Vref supplied from the reference power supply section 45, the conversion of the direct voltage is performed by the DC/DC converter 46. The generated power supply voltage of the source driver 51 is supplied to the source driver 51, and the generated gate-on voltage Von, and the three gate-off voltages Voff1, Voff2, and Voff3 are respectively supplied to the gate driver 52.

Here, for example as shown in FIG. 6, in the gate driver 52, the gate voltages to be supplied to each of the gate lines are generated on the basis of the drive timing control signals (specifically, the strobe signal STV and the pulse signal (clock signal) CPV) supplied from the signal process section 42, and the gate-on voltage Von and the gate-off voltages Voff1, Voff2, and Voff3 supplied from the DC/DC converter 46.

Specifically, in the shift register section 521 as shown in FIG. 4, the strobe signals STV1 to STV4 or the like respectively indicating the timing waveforms (timings t0 to t5) as shown, for example, in (C) to (F) in FIG. 6 are generated on the basis of the strobe signal STV ((A) in FIG. 6) and the pulse signal CPV ((B) in FIG. 6) supplied from the signal process section 42.

Next, in the output section 522 as shown in FIG. 5, the gate voltages VG(1), VG(2), VG(3), . . . respectively indicating the timing waveforms (timings t1 to t5) as shown, for example, in (G) to (I) in FIG. 6 are generated on the basis of strobe signals STV1, STV2, STV3, STV4, . . . supplied from the shift register section 521, and the gate-on voltage Von and the gate-off voltages Voff1, Voff2, and Voff3 supplied from the DC/DC converter 46. That is, the line-sequential gate voltages are generated by using the four values of the gate-on voltage Von and the gate-off voltages Voff1, Voff2, and Voff3 (generated are the gate voltages of four-value drive). Thereby, each of the pixels 20 in the liquid crystal display panel 2 is line-sequentially driven by the four-values along the gate line.

On the other hand, in the source driver 51, by following the drive timing control signal supplied from the signal process section 42, the image signal D2 of the current frame stored in the frame memory 44 is inputted as the image signal Dout, and the drive voltage (source voltage) on the basis of the image signal Dout is generated and supplied to each of the pixels 20 of the liquid crystal display panel 2 along the source line.

Here, by the drive voltage (the gate voltage and the source voltage) outputted from the gate driver 52 and the source driver 51 to each of the pixels 20, the drive operation of the line-sequential display is performed to the each of the pixels 20. Specifically, in the pixel circuit unit in the pixel 20 (m, n) in FIG. 2, a so-called line inversion drive is operated in the following way.

First, when the image signal Dout for the pixel 20 (m, n) is supplied from the source driver 51 through the source line S(m), and a selection signal (specifically the gate-on voltage Von of the gate voltage VG (n)) for the pixel 20 (m, n) is supplied from the gate driver 52 through the gate line G(n), the pulsed electric potential (the electric potential of the gate-on voltage Von) is generated on the gate line G(n). Thereby, the TFT element Q (m, n) becomes on-state, and the electric current on the basis of the image signal Dout flows through the connection line L1 and the electric charge is accumulated (the image data is supplied) on the one end of the liquid crystal element LC and the one end of the auxiliary capacitive element Cs. That is, the voltage on the basis of the image signal Dout is respectively applied across the liquid crystal element LC and the auxiliary capacitive element Cs (m, n) in the pixel 20 (m, n).

Next, when the TFT element Q (m, n) selectively becomes off-state by the gate-off voltage Voff2 or the gate-off voltage Voff3 supplied from the gate line G(n) (as shown in (G) and (I) in FIG. 6, the gate-off voltage Voff2 is selected for the positive electrode, and the gate-off voltage Voff3 is selected for the negative electrode), the supply of the image signal Dout from the source line S(m) is stopped and thereby the voltage across the liquid crystal element LC and the auxiliary capacitive element Cs (m, n) in the pixel 20 (m, n) is maintained.

Next, like a change from the electric potential of the gate-off voltage Voff2 to the electric potential of the gate-off voltage Voff1, and the change from the electric potential of the gate-off voltage Voff3 to the electric potential of the gate-off voltage Voff1 as shown, for example, with arrows P21 to P23 of (G) to (I) in FIG. 6, when the electric potential of the gate-off voltage is changed with time and supplied to the other end (facing electrode) of the auxiliary capacitive element (m, n) by the adjacent gate line G (n+1) which is the gate line adjacently located in the direction of the line-sequential operation along the source line S(m), correspondingly the voltage across the auxiliary capacitive element Cs (m, n) and the liquid crystal element LC is also changed from the voltage based on the abovementioned image signal Dout (operation of the so-called Cs on gate method).

By the drive operation of the line-sequential display in the liquid crystal display panel 2 as described above, the illumination light emitted from the backlight section 3 by the drive operation of the backlight drive section 6 is modulated by the liquid crystal display panel 2 for each of the pixels 20, and is outputted from the liquid crystal display panel 2 as the display light. Thereby, the image display is performed by the display light on the basis of the input image signal Din.

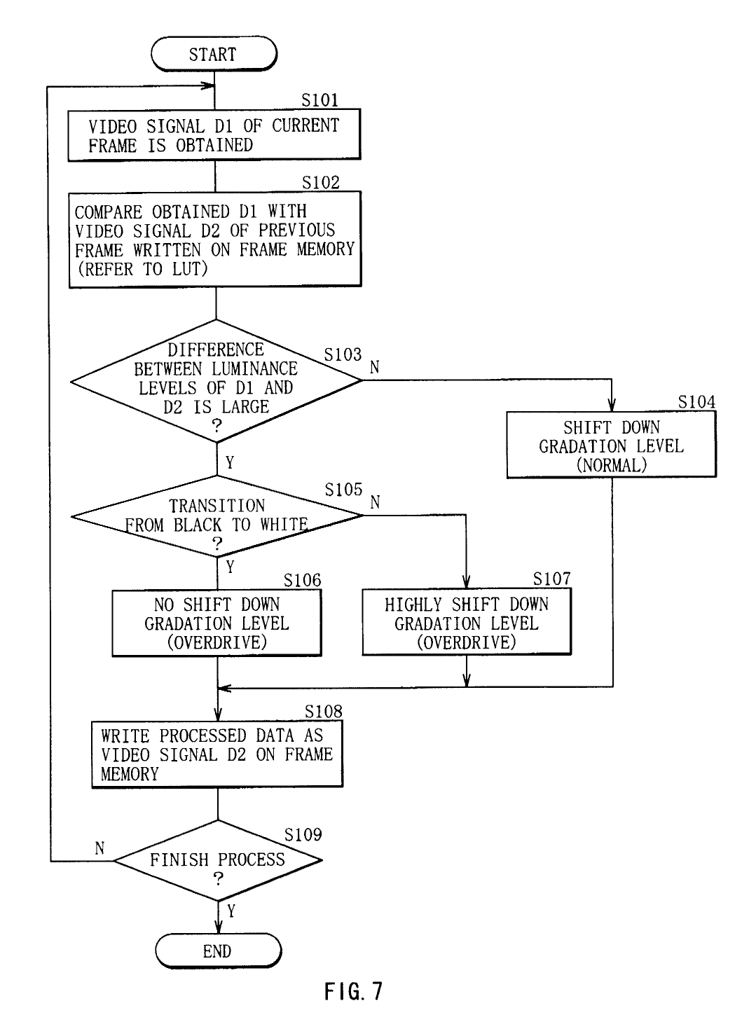

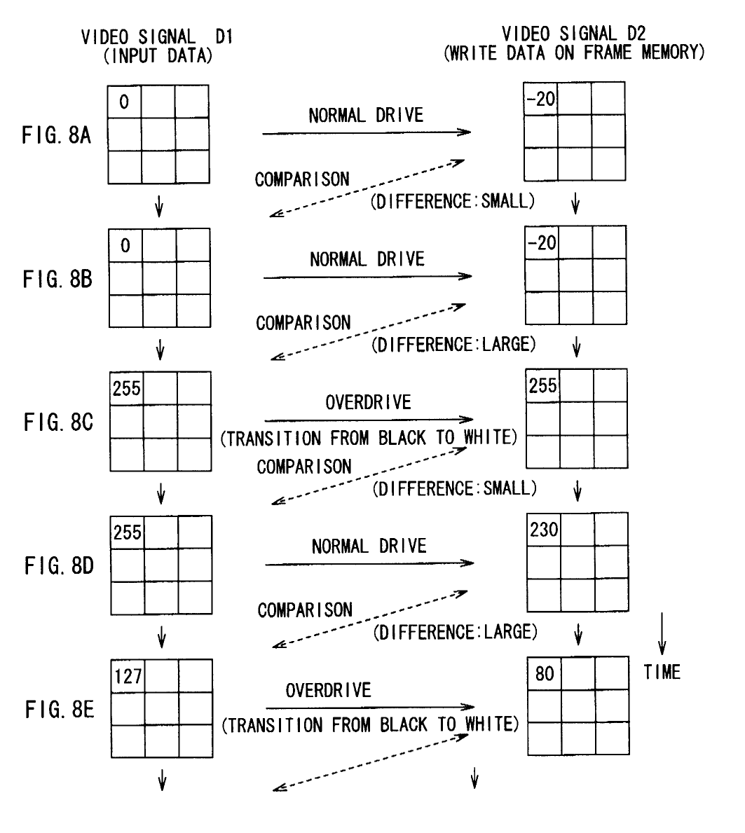

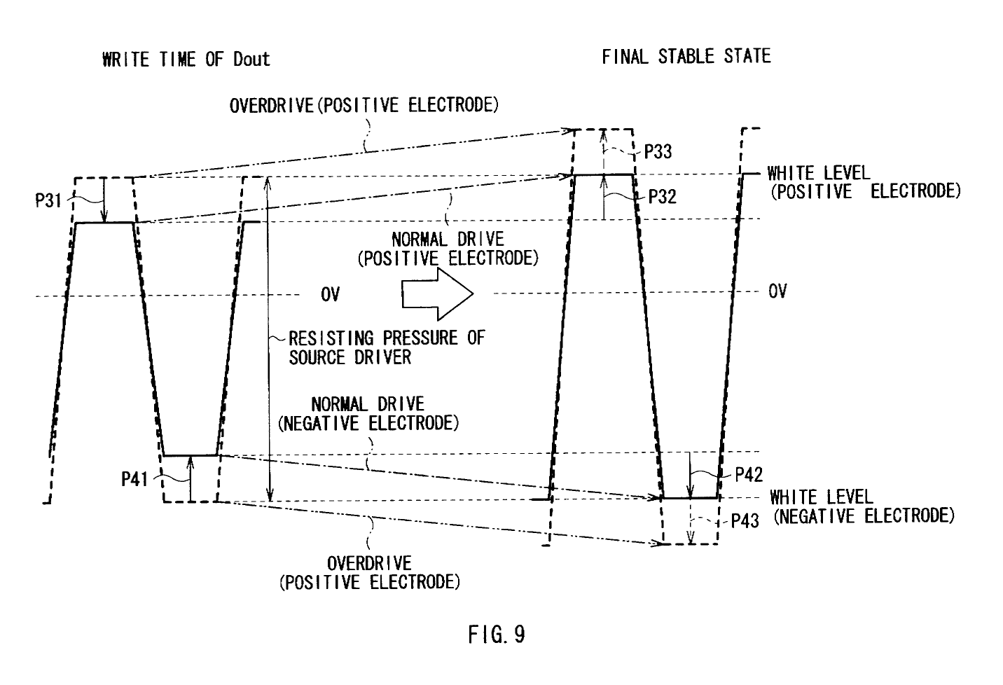

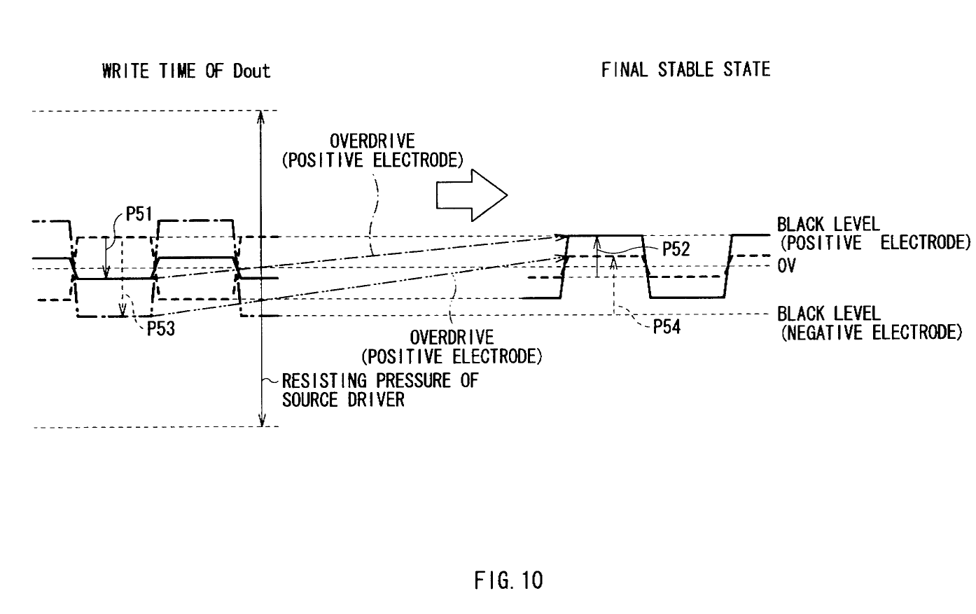

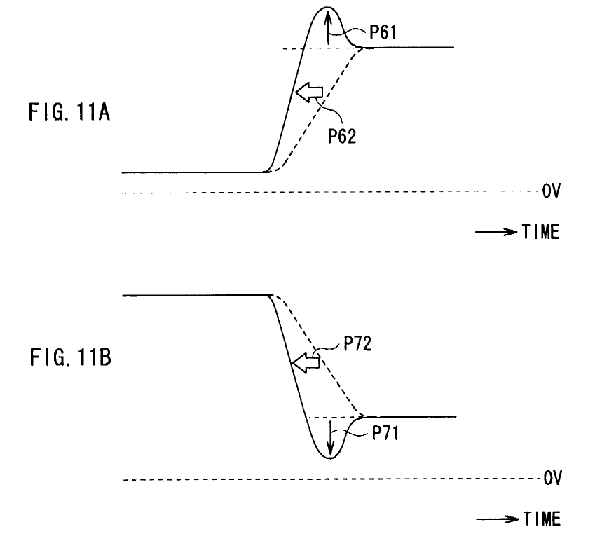

Next, with reference to FIGS. 1 to 2, and FIGS. 4 to 6, and additionally to FIG. 3 and FIGS. 7 to 11A and 11B, as one of the features of the present invention, the determination process of the drive method by the overdrive process section 43 and the correction process of the image signal D1 of the current frame will be described in detail. Here, FIG. 7 shows a flow chart regarding an example of such a process by the overdrive process section 43. FIGS. 8A to 8E show timing diagrams0 of the relationship between the change of the image signal D1 (the input data to the overdrive process section 43) and the image signal D2 (the write data on the frame memory 44) accompanied by time lapse in each frame unit, and the process by the overdrive process section 43, where each of numbers shown in the upper left section in each grid of 3-3 in FIGS. 8A to 8E indicates a pixel data (a gradation level (0 to 255 gradation) of the luminance of the image signal) in one pixel 20. FIG. 9 shows a waveform of the voltage applied across the liquid crystal element LC during the white display state at the time when the image signal Dout is written on each of the pixels 20 and at the time of the final stable state. FIG. 10 shows a waveform of the voltage applied across the liquid crystal element LC during the black display state at the time when the image signal Dout is written on each of the pixels 20 and at the time of the final stable state. Also, FIGS. 11A and 11B shows, by a timing diagram, a waveform of the voltage applied across the liquid crystal element LC during the overdrive, while FIG. 11A showing the overdrive at the time of the transition from the black display to the white display, and FIG. 11B showing the overdrive at the time of the transition from the white display to the black display, respectively.

The overdrive process section 43 obtains the image signal D1 of the current frame from the signal process section 42 (step S101 in FIG. 7). Then, for example, by referring to the look-up table shown in FIG. 3, the overdrive process section 43 compares the obtained image signal D1 of the current frame with the corrected image signal D2 of the previous frame which is written (stored) on the frame memory 44 (step S102). Thereby, the overdrive process section 43 determines whether the difference between the luminance level (difference between the gradation levels of the luminance) of the image signal D1 and the luminance level of the image signal D2 is large (whether it is larger than the threshold value defined by the look-up table 7) to an extent that the overdrive process is necessary (step S103).

Specifically, for example as shown in FIGS. 8A to 8E, when the previous image signal D2 shown in FIG. 8A is compared with the current image signal D1 shown in FIG. 8B (step S103), the difference between the gradation level of the luminance of the image signal D1 and the gradation level of the luminance of the image signal D2 is smaller than the threshold value (Step S103: N) so that it is determined to drive a display of the normal drive in this pixel, and a normal process which is the correction to shift down the gradation level of the luminance of the image signal D1 of the current frame is performed (Step S104, FIG. 8B, and an arrow P51 of FIG. 10). Thus, as shown in FIG. 8B, the data of the gradation level “−20” is written on the frame memory 44 as the corrected image signal D2 of the current frame (Step S108). At this time, by the operation of the abovementioned Cs on gate method, when the voltage across the auxiliary capacitive element Cs (m, n) and the liquid crystal element LC is then changed from the voltage based on the image signal D2 (Dout) and becomes the stable state (in the final stable state), for example as shown in FIG. 10, by the normal drive (positive electrode), the luminance level based on the image signal D2 after being corrected becomes equivalent to the original luminance level (for example, black level (positive electrode) in the figure) based on the image signal D1 before being corrected. Thereby, the luminance level becomes unchanged before and after the correction.

After that, it is determined whether to finish the whole process by the overdrive process section 43 or not (Step S109). If it is determined not to finish the whole process (Step S109: N), it returns to the step S101.

Next, similarly to the above, after the steps S101 and S102, when the previous image signal D2 shown in FIG. 8B is compared with the current image signal D1 shown in FIG. 8C (step S103), the difference between the gradation level of the luminance of the image signal D1 and the gradation level of the luminance of the image signal D2 is larger than the threshold value (Step S103: Y) so that it is determined to drive the display of the overdrive in this pixel. Then, the overdrive process section 43 determines whether the transition from the previous frame to the current frame is the transition from the black display state to the white display state (step S105). Here, as shown in FIGS. 8B and 8C, the transition is from the black display state to the white display state (step S105: Y) so that the overdrive process section 43 performs the overdrive process as it is (step S106 and FIG. 8C) without changing the gradation level of the luminance (without shifting the gradation level of the luminance) of the image signal D1 of the current frame. Thus, as shown in FIG. 8C, the data of the gradation level “255” as it is is written on the frame memory 44 as the corrected image signal D2 of the current frame (Step S108). Therefore, for example, by the overdrive (positive electrode) as shown in FIG. 9, the overdrive is performed using the operation of the Cs on gate method, and thereby, for example, as shown with an arrow P61 in FIG. 11A, the voltage change across the liquid crystal element LC between the previous frame and the current frame becomes larger than the original voltage change based on the image signal D1 (the image data before being corrected) of the current frame, and as shown with an arrow P62 in FIG. 11A, the response speed of the liquid crystal at the time of the transition from the black display state to the white display state is improved.

Next, similarly to the above, after the steps S109, S101, and S102, when the previous image signal D2 shown in FIG. 8C is compared with the current image signal D1 shown in FIG. 8D (step S103), the difference between the gradation level of the luminance of the image signal D1 and the gradation level of the luminance of the image signal D2 is smaller than the threshold value (Step S103: N) so that it is determined to drive the display of the normal drive in this pixel, and the normal process which is the correction to shift down the gradation level of the luminance of the image signal D1 of the current frame is performed (Step S104, FIG. 8D, and an arrow P31 in FIG. 9). Thus, as shown in FIG. 8D, the data of the gradation level “230” is written on the frame memory 44 as the corrected image signal D2 of the current frame (Step S108), and for example as shown in FIG. 9, by the normal drive (positive electrode), the normal drive using the operation of the Cs on gate method is performed.

Next, similarly to the above, after the steps S109, S101, and S102, when the previous image signal D2 shown in FIG. 8D is compared with the current image signal D1 shown in FIG. 8E (step S103), the difference between the gradation level of the luminance of the image signal D1 and the gradation level of the luminance of the image signal D2 is larger than the threshold value (Step S103: Y) so that it is determined to drive the display of the overdrive in this pixel. Then, as described above, the overdrive process section 43 determines whether the transition from the previous frame to the current frame is the transition from the black display state to the white display state (step S105). Here, as shown in FIGS. 8D and 8E, the transition is from the white display state to the black display state (step S105: N) so that the overdrive process section 43 performs the overdrive process which is the correction to highly shift down the gradation level of the luminance of the image signal D1 of the current frame in comparison with the correction of the normal drive (as shown with the arrow P51 in FIG. 10) (Step S107, FIG. 8E, and an arrow P53 in FIG. 10). Thus, as shown in FIG. 8E, the data of the gradation level “80” is written on the frame memory 44 as the corrected image signal D2 of the current frame (Step S108). Therefore, for example, by the overdrive (positive electrode) as shown in FIG. 10, the overdrive is performed using the operation of Cs on gate method, and thereby, for example, as shown with an arrow P71 in FIG. 11B, the voltage change across the liquid crystal element LC between the previous frame and the current frame becomes larger than the original voltage change based on the image signal D1 (the image data before being corrected) of the current frame, and as shown with an arrow P72 in FIG. 11B, the response speed of the liquid crystal at the time of the transition from the white display state to the black display state is improved.

As shown with the arrows P41, P42, and P43 in FIG. 9, the normal drive (negative electrode) and the overdrive (negative electrode) in the white display state as shown in FIG. 9 take the operations similar to the case of the normal drive (positive electrode) and the overdrive (positive electrode) in the white display state which is described above, thereby the description is omitted. Also, the normal drive (negative electrode) and the overdrive (negative electrode) in the black display state which are not shown in the figure take the operations similar to the case of the normal drive (positive electrode) and the overdrive (positive electrode) in the black display state which is described above, thereby the description is omitted.

In this way, in the liquid crystal display 1 of the embodiment, when the TFT element Q in the pixel 20 to be driven selectively becomes on-state by the gate-on voltage Von supplied from the gate line G, the image signal Dout is supplied from the source line S through the TFT element Q. Then, the voltage based on the image signal Dout is respectively applied across the liquid crystal element LC and the auxiliary capacitive element Cs in the pixel 20. After that, when the TFT element Q selectively becomes off-state by one gate-off voltage (Voff2 or Voff 3) of the plurality of kinds of gate-off voltages Voff1, Voff2, and Voff3 supplied from the gate line G, the supply of the image signal Dout from the source line S is stopped and the voltage across the liquid crystal element LC and the auxiliary capacitive element Cs is maintained. Then, when the electric potential of the plurality of kinds of gate-off voltages is changed with time and supplied to the other end (facing electrode) of the auxiliary capacitive element Cs by the adjacent gate line which is the gate line adjacently located in the direction of the line-sequential operation along the source line S, the voltage across the auxiliary capacitive element Cs and the liquid crystal element LC is changed from the voltage based on the image signal Dout.

Here, in the normal drive mode, because the display is driven on the basis of the image signal D2 after being corrected for shifting down the luminance level of the image signal D1 of the current frame by the predetermined gradation, it is adjustable that the original voltage value on the basis of the image signal D1 before being corrected is respectively applied (the overdrive is not performed, that is, the normal drive is performed) across the auxiliary capacitive element Cs and the liquid crystal element LC, after the voltage across the auxiliary capacitive element Cs and the liquid crystal element LC is changed as described above. In the overdrive mode, because the display is driven on the basis of the image signal (the image signal D2 after being corrected) in which the voltage change across the liquid crystal element LC becomes larger than the original voltage change based on the image signal D1 of the current frame, the voltage value larger than the original voltage value on the basis of the image signal D1 before being corrected is respectively applied across the auxiliary capacitive element Cs and the liquid crystal display element LC, after the voltage across the auxiliary capacitive element Cs and the liquid crystal element LC is changed as described above, and thereby the display in which the voltage change becomes larger than the original voltage change is performed, that is, the overdrive is performed. Therefore, by such a configuration and operations, in the embodiment, the response speed of the liquid crystal may be improved without increasing the resisting pressure of the TFT element Q which is the drive element.

Specifically, the overdrive process section 43 determines to perform either the display of the normal drive or the display of the overdrive for each of the pixels 20 in the current frame on the basis of the image signal D1 of the current frame and the image signal D2 of the previous frame, and the correction of the image signal D1 of the current unit frame is performed for each of the pixels 20 on the basis of the determination result so that the abovementioned operations are obtainable. Also, at the time of the determination, in the case of the pixel 20 where the difference between the luminance level of the image signal of the current frame and the luminance level of the image signal of the previous frame is equal to or larger than the threshold value, the overdrive process section 43 determines to drive the display by the overdrive. On the other hand, in the case of the pixel 20 where the difference between the luminance level of the image signal of the current frame and the luminance level of the image signal of the previous frame is smaller than the threshold value, the overdrive process section 43 determines to drive the display by the normal drive. Therefore the abovementioned operations are obtainable.

Also, at the time of the correction, in the pixel where the abovementioned difference between the luminance levels is equal to or larger than the threshold value, the correction of the image signal D1 of the current frame is performed in a manner that the voltage change across the liquid crystal element LC becomes larger as the difference between the luminance levels becomes larger. Therefore the amount of the overdrive is adjustable according to the necessity for the improvement of the response speed of the liquid crystal.

In the overdrive mode, in the pixel where the transition is made from the black display state to the white display state, because the display is driven by using the image signal D1 of the current frame as it is without changing the luminance level of the image signal D1 of the current frame, the voltage value larger than the original voltage value of the white display state on the basis of the image signal D1 before being corrected is respectively applied across the auxiliary capacitive element Cs and the liquid crystal element LC, after the voltage across the auxiliary capacitive element Cs and the liquid crystal element LC is changed. Thereby, the display in which the voltage change becomes larger than the original voltage change at the time of the transition from the black display state to the white display state can be driven, that is, the overdrive can be performed at the time of the transition from the black display state to the white display state.

Also, in the overdrive mode, in the pixel where the transition is made from the white display state to the black display state, because the display is driven on the basis of the image signal D2 after being corrected for highly shifting down the luminance level of the image signal D1 of the current frame in comparison with the correction of the normal drive, the voltage value smaller than the original voltage value of the black display state on the basis of the image signal D1 before being corrected is respectively applied across the auxiliary capacitive element Cs and the liquid crystal element LC, after the voltage across the auxiliary capacitive element Cs and the liquid crystal element LC is changed. Thereby, the display drive in which the voltage change becomes larger than the original voltage change at the time of the transition from the white display state to the black display state can be performed, that is, the overdrive can be performed at the time of the transition from the white display state to the black display state.

Further, at the time of the normal drive, when the voltage across the liquid crystal element LC is in the stable state, the luminance level on the basis of the image signal D2 after being corrected becomes equivalent to the luminance level on the basis of the image signal D1 before being corrected. Thus, when the voltage across the auxiliary capacitive element Cs and the liquid crystal element LC is changed so that the voltage across the liquid crystal element LC is in the stable state, because the luminance level on the basis of the image signal D2 after being corrected becomes equivalent to the luminance level on the basis of the image signal D1 before being corrected, the overdrive can be performed while the luminance level in the normal drive is adjusted to be unchanged (that is, the change of the display luminance is not accompanied).

Hereinbefore, the present invention is described with the embodiment. However, the present invention is not limited to the embodiment as various modifications are available.

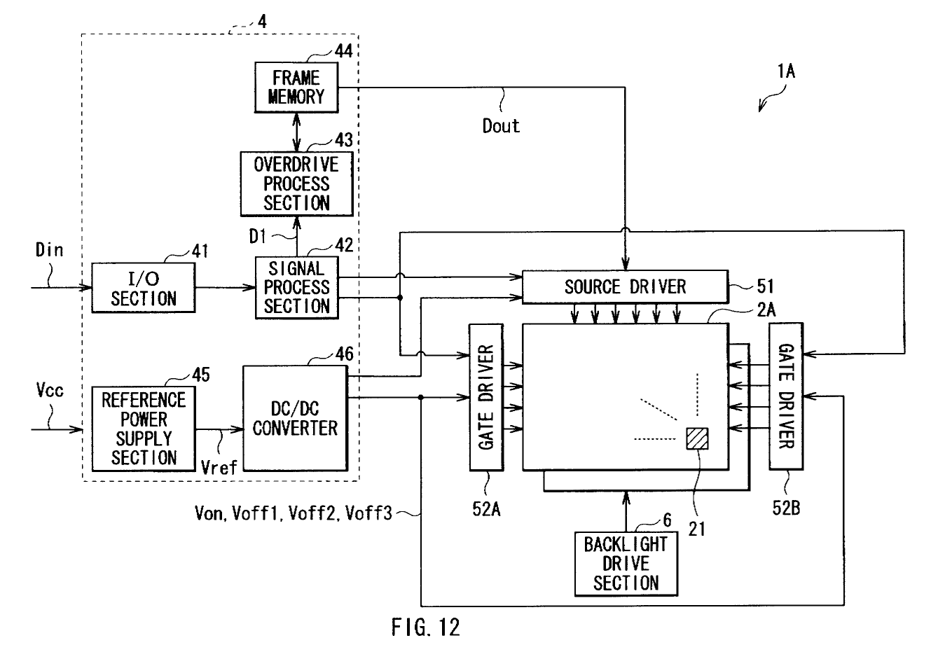

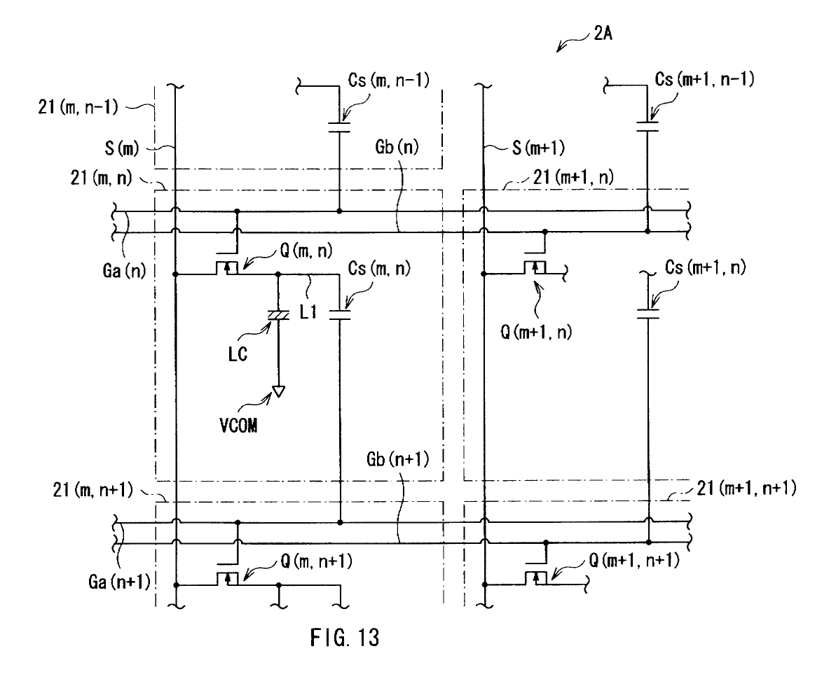

For example, in the embodiment, the case is explained where the display is driven for each pixel circuit unit in the liquid crystal display panel 2 by the so-called line inversion. However, for example, the display may be driven by a so-called frame inversion or a so-called dot inversion. Specifically, in the case of the display drive by the dot inversion, like the liquid crystal display 1A equipped with the liquid crystal display panel 2A as shown, for example, in FIG. 12, two gate drivers 52A and 52B corresponding to the gate driver 52 in the embodiment are provided. Also, for example as shown in FIG. 13, in the pixels 21 in the liquid crystal display panel 2A, the display is driven in a manner that two gate lines Ga (which is connected to the gate driver 52A) and Gb (which is connected to the gate driver 52B) are alternately connected to the TFT element Q and the auxiliary capacitive element Cs in the two adjacent pixels 21, and the voltage of reverse polarities is applied (dot inversion) across the liquid crystal element LC, in the two adjacent pixels 21 along the gate lines Ga and Gb, respectively, and in the two adjacent pixels 21 along the source line S, respectively.

Further, the embodiment, the case is explained where the three kinds of gate-off voltages Voff1, Voff2, and Voff3 are generated by the DC/DC converter 46, and the gate driver 52 generates the gate voltage (four-value drive) by using the three kinds of gate-off voltages Voff1, Voff2, and Voff3. However, the number of kinds of the gate-off voltages is not limited to this. For example, four or more kinds of gate-off voltages may be used.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid crystal display comprising:
a plurality of pixels disposed in a matrix form, each of the pixel including a TFT element, a liquid crystal element functioning as a main capacitive element, and an auxiliary capacitive element,
a gate line selecting a pixel to be driven in a line-sequential manner so that the TFT element in the selected pixel is selectively changed to on-state through application of on-voltage, and selectively changed to off-state through application of off-voltages,
a source line supplying an image data to the pixel to be driven through the TFT element, and
a drive section driving the pixels for display in a line-sequential manner,
wherein one end of the liquid crystal element is connected to one end of the TFT element, one end of the auxiliary capacitive element is connected to the one end of the TFT element while other end of the auxiliary capacitive element is connected to an adjacent gate line, and the drive means refers to image data both of a current unit frame and a previous unit frame, so that,
in a normal drive mode, the drive means drives the pixels one by one on the basis of an image data obtained through correction in which image luminance level of the current unit frame is lowered by a predetermined amount, and
in an overdrive mode, the drive means drives the pixels one by one on the basis of an image data which allows a larger change of a voltage across the liquid crystal element between the previous unit frame and the current unit frame.

2. The liquid crystal display according to claim 1, wherein the drive means includes:
a determination means for referring to the image data both of the current unit frame and the previous unit frame, and determining, pixel by pixel, whether the normal drive mode or the overdrive mode is to be performed for the current frame; and
a correction means for correcting the image data of the current unit frame, pixel by pixel, on the basis of a determination result from the determination means.

3. The liquid crystal display according to claim 2, wherein the determination means determines to perform the overdrive mode for a pixel in which luminance level difference between the current unit frame and the previous unit frame is equal to or larger than a threshold value, while determines to perform the normal drive mode for a pixel in which the luminance level difference is smaller than the threshold value.

4. The liquid crystal display according to claim 3, wherein, in the overdrive mode, the correction means corrects the image data of the current unit frame for the pixel in which the luminance level difference is equal to or larger than the threshold value so that an amount of change of voltage across a liquid crystal element increases as the luminance level difference increases.

5. The liquid crystal display according to claim 1, wherein the drive means performs the overdrive mode by using the image data of the current unit frame without changing the luminance level thereof, for the pixel to be changed from a black display state to a white display state.

6. The liquid crystal display according to claim 1, wherein the drive means performs the overdrive mode by using the image data corrected in such a manner that the luminance level of the current unit frame is lowered by an amount which is larger than the predetermined amount in the normal drive mode.

7. The liquid crystal display according to claim 1, wherein the image luminance level based on corrected image data after stabilization of the voltage across the liquid crystal element in the normal drive mode is equivalent to a image luminance level based on non-corrected image data just after application of a voltage across the liquid crystal element.

8. The liquid crystal display according to claim 1, wherein two gate lines are provided for a row of the plurality of pixels along the gate line, each of the two gate lines connected to a gate of the TFT element in every other pixel in the row, and
the drive means drives the pixels in such a manner that a couple of voltages with different polarities are applied across the liquid crystal elements in two pixels adjacent to each other along the gate lines, respectively, as well as in two pixels adjacent to each other along the source line, respectively.

9. A liquid crystal drive circuit applied to a liquid crystal display, the liquid crystal display comprising:
a plurality of pixels disposed in a matrix form, each of the pixel including a TFT element, a liquid crystal element functioning as a main capacitive element, and an auxiliary capacitive element,
a gate line selecting a pixel to be driven in a line-sequential manner so that the TFT element in the selected pixel is selectively changed to on-state through application of on-voltage, and selectively changed to off-state through application of off-voltages, and
a source line supplying an image data to the pixel to be driven through the TFT element, the liquid crystal drive circuit driving the pixels for display in a line-sequential manner,
wherein one end of the liquid crystal element is connected to one end of the TFT element, one end of the auxiliary capacitive element is connected to the one end of the TFT element while other end of the auxiliary capacitive element is connected to an adjacent gate line, and the drive means refers to image data both of a current unit frame and a previous unit frame, so that:
in a normal drive mode, the drive means drives the pixels one by one on the basis of an image data obtained through correction in which image luminance level of the current unit frame is lowered by a predetermined amount, and
in an overdrive mode, the drive means drives the pixels one by one on the basis of an image data which allows a larger change of a voltage across the liquid crystal element between the previous unit frame and the current unit frame.
